(19) United States
(12) Patent Application Publication
(10) Pub. No.: US 2011/0084564 A1
(43) Pub. Date: Apr. 14, 2011

(54) PERMANENT-MAGENT MOTOR

(75) Inventor: Wei-Ming HUANG, Changhua County (TW)

(73) Assignee: J-STAR MOTOR INDUSTRIAL CO., LTD., Pitou Township (TW)

(21) Appl. No.: 12/732,413

(22) Filed: Mar. 26, 2010

(30) Foreign Application Priority Data
Oct. 14, 2009 (TW) 98218968

(51) Int. Cl. H02K 1/18

(52) U.S. Cl. 310/154.12

(57) ABSTRACT

A permanent-magnet motor composed of an irony barrel, a magnet set, a magnet holder, and a rotor. The irony barrel includes a thin body. The magnet set includes a plurality of magnets. The magnet holder is received inside the irony holder and includes a plurality of retaining pieces located at an internal edge thereof for holding the magnet set. The rotor includes a rotor silicon steel sheet, a deflector, a rotary shaft, a front bearing, and a rear bearing, being inserted inside the magnet set. In light of this, the magnet set can not only maintain the same thickness as that of the conventional irony barrel but also reduce the thickness of the front and rear parts of the irony barrel, so that the production cost of the irony material can be effectively decreased. Besides, the magnet holder can definitely space and position the magnets to enhance the assembly efficiency.

### BACKGROUND OF THE INVENTION

1. Field of the Invention

The present invention relates generally to motors, and more particularly, to a permanent-motor motor.

2. Description of the Related Art

Referring to FIG. 1, a conventional permanent-magnet motor 1 includes an irony barrel 2 whose body has a uniform thickness W throughout; a magnet set 3 composed of two arched magnets 3a and 3b received in and magnetically attached inside the irony barrel 2; a rotor 4 inserted inside the magnet set 3 and having a rotary shaft 5 inserted through a center thereof; a front cover 6 having an axial hole 6a and two threaded hole 6b, the former of which is provided for a front end of the rotary shaft 5 to pass through; a rear cover 7 structurally similar to the front cover 6 to have an axial hole 7a and two through holes 7b, the former of which is provided for a rear end of the rotary shaft to pass through; and two screw bolts 8 each inserted through one of the two through holes 7b and each screwed with one of the two threaded holes 6b by an external threads formed at a front end thereof in such a way that the rotor 4 and the magnet set 3 are sealed inside the irony barrel 2.

However, the aforesaid conventional permanent-magnet motor 1 includes some drawbacks. For example, the uniform thickness of the irony barrel 2 is costly in material, so that it is difficult to effectively reduce the production cost of the motor 1. Besides, the two magnets 3a and 3b are though attached inside the irony barrel 2 and located close to the center of the irony barrel 2 symmetrically, but they are not stably positioned. In this way, when the two screw bolts 8 are inserted through the two through holes 7b and then into the threaded holes 6b, they are subject to the hinder of the magnet set 3 in deviation, so that they fail to rapidly and smoothly combine the front cover 6 and the rear cover 7. Therefore, the whole assembly of the motor 1 is slow to increase the production cost.

### SUMMARY OF THE INVENTION

The primary objective of the present invention is to provide a permanent-magnet motor, which can effectively lower the material cost and enhance assembly efficiency for more product competitiveness.

The foregoing objective of the present invention is attained by the permanent-magnet motor composed of an irony barrel, a magnet set, a magnet holder, and a rotor. The irony barrel includes a thin body. The magnet set includes a plurality of magnets. The magnet holder is received inside the irony holder and includes a plurality of retaining pieces located at an internal edge thereof for holding the magnet set. The rotor includes a rotor silicon steel sheet, a deflector, a rotary shaft, a front bearing, and a rear bearing, being inserted inside the magnet set.

In light of the above structure, i.e. the thin irony barrel and the magnet holder, the magnet set can not only maintain the same thickness as that of the conventional irony barrel but also reduce the thickness of the front and rear parts of the irony barrel, so that some production costs of the irony material can be effectively decreased. Besides, the magnet holder can definitely space and position the magnets to help enhance the assembly efficiency for better product competitiveness.

### BRIEF DESCRIPTION OF THE DRAWINGS

FIG. 1 is an exploded view of a conventional permanent-magnet motor.

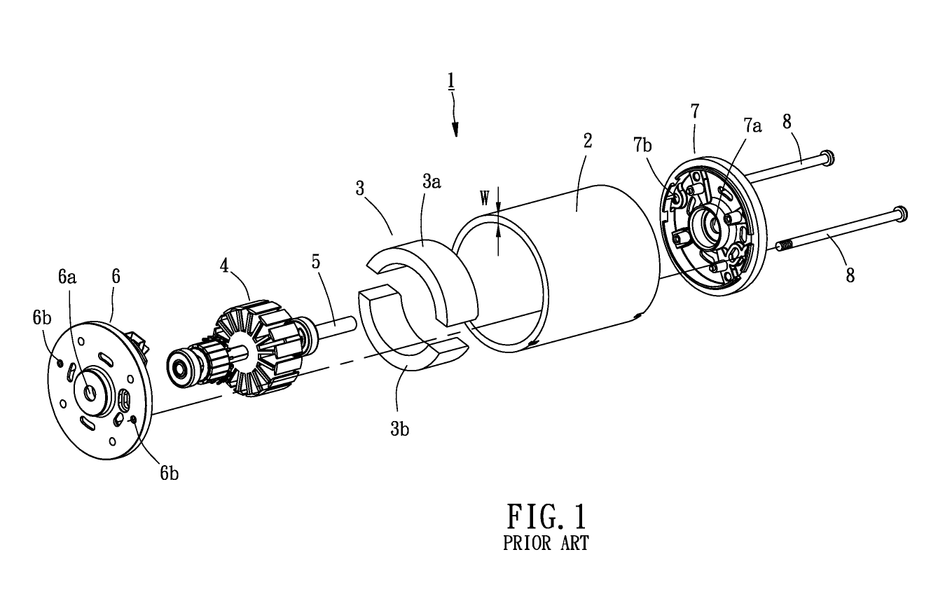

FIG. 2 is a perspective view of a first preferred embodiment of the present invention.

FIG. 3 is an exploded view of the first preferred embodiment of the present invention.

FIG. 4 is a sectional view taken along a line 4-4 indicated in FIG. 2.

FIG. 5 is a sectional view taken along a line 5-5 indicated in FIG. 2.

FIG. 6 is an exploded view of a second preferred embodiment of the present invention.

FIG. 7 is a sectional view of the second preferred embodiment of the present invention.

FIG. 8 is an exploded view of a third preferred embodiment of the present invention.

FIG. 9 is a perspective view of the third preferred embodiment of the present invention.

### DETAILED DESCRIPTION OF PREFERRED EMBODIMENTS

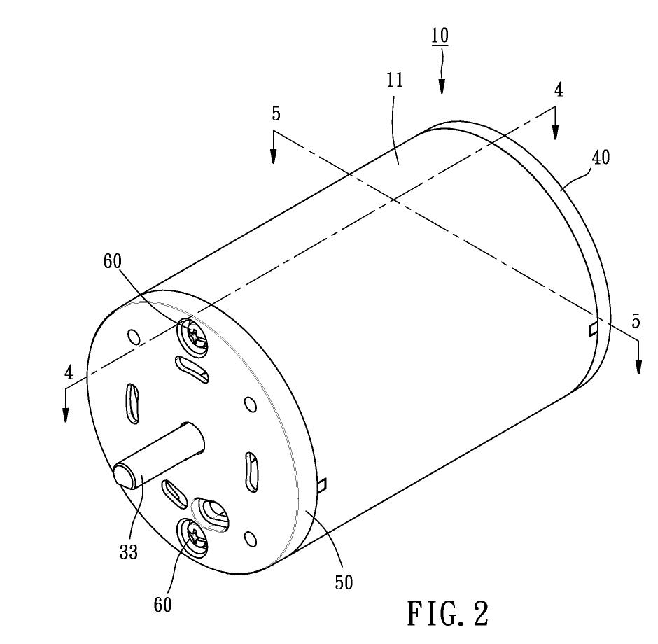

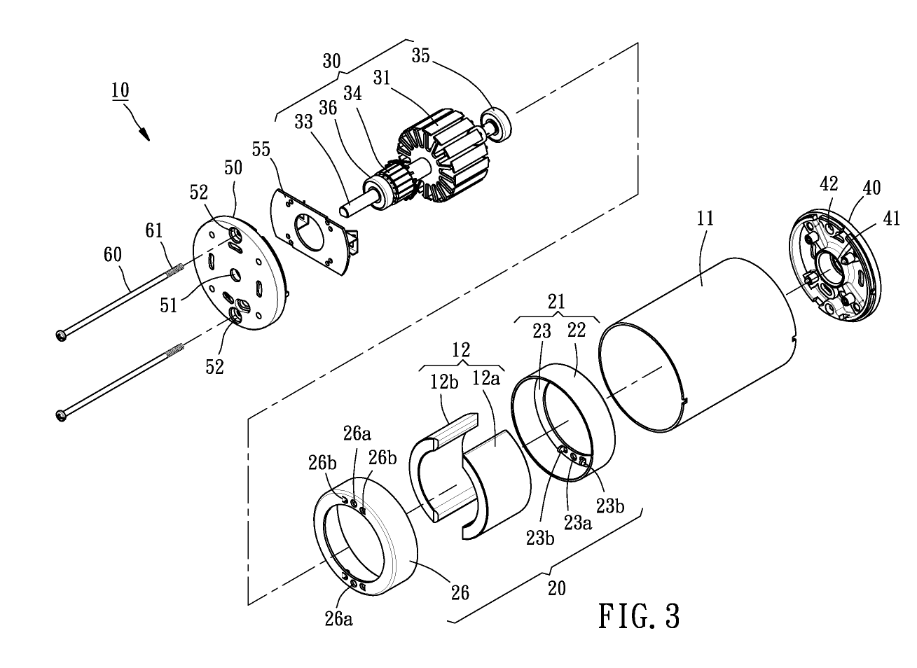

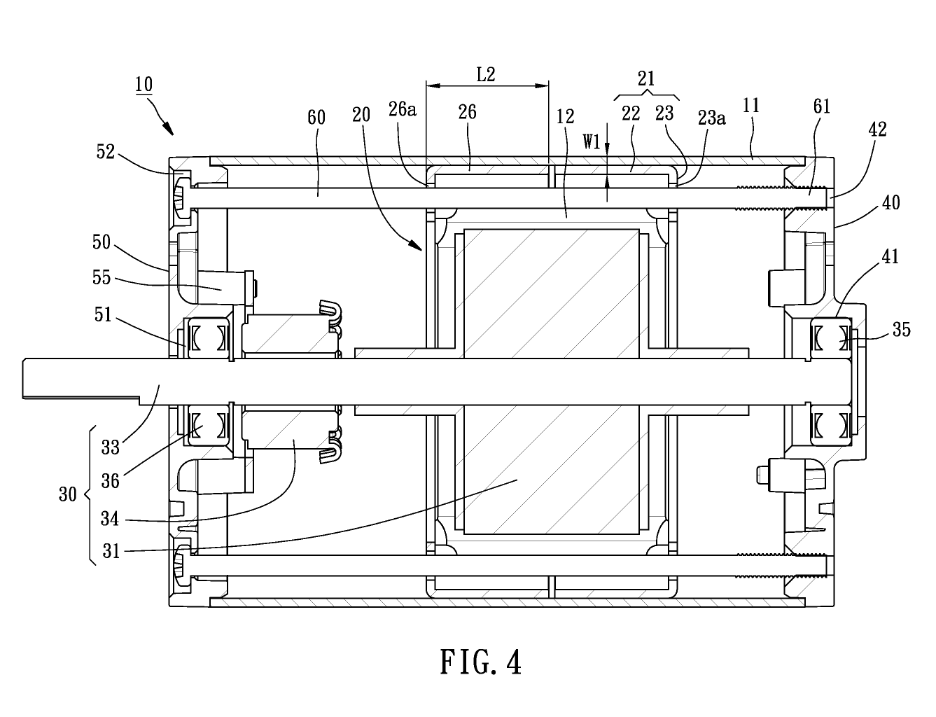

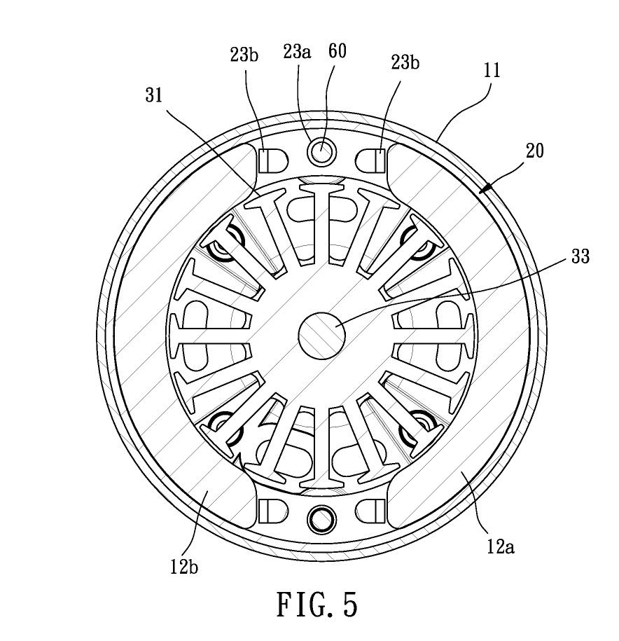

Referring to FIGS. 2-5, a DC permanent-magnet motor 10 constructed according to a first preferred embodiment of the present invention is composed of a barrel assembly, a rotor assembly 30, a front cover 40, a rear cover 50, and two elongated screw bolts 60.

The barrel assembly includes an irony barrel 11, a magnet set 12, and a magnet holder 20. The irony barrel 11 includes a thin body. The magnet set 12 is composed of an arched magnets 12a and 12b symmetrically. The magnet holder 20 is composed of a front shell 21 and a rear shell 26. The front shell 21 includes an annular body 22 having an annular end sidewall 23 extending toward an imaginary central axis thereof from a front end edge thereof. The end sidewall 23 includes two through holes 23a running through two opposite sides thereof respectively; and two retaining pieces 23b formed beside each of the two through holes 23a. Each of the retaining pieces 23b is a lug in this embodiment. The rear shell 26 is structurally similar to the front shell 21 to include an annular end sidewall, two through holes 26a, and two pairs of the retaining pieces 26b. When the front shell 21 and the rear shell 26 are butted with each other to encase the two magnets 12a and 12b, two free ends of the magnet 12a are retained by the two farther spaced retaining pieces 23b and the two farther spaced retaining pieces 26b respectively in such a way that the magnet 12a is held at one half (right) side inside the magnet holder 20; meanwhile, the magnet 12b is likewise held at the other half (left) side inside the magnet holder 20 by the other farther spaced retaining pieces 23b and 26b. In this way, the two magnets 12a and 12b are firmly positioned at the two half (left and right) sides inside the magnet holder 20, the through holes 23a and 26a are coaxially aligned with each other, and the two magnets 12a and 12b are obviously spaced from each other, thus facilitating the product assembly.

The rotor assembly 30 includes a rotor silicon steel sheet 31, a rotary shaft 33, a deflector 34, a front bearing 35, and a rear bearing 36, being inserted inside the magnet set 12. The front cover 40 includes an axial hole 41 and two threaded holes 42, the former of which is provided for a front end of the rotary shaft 33 to pass through. The rear cover 50 is structurally similar to the front cover 40 to include an axial hole 51 and two through holes 52, the former of which is provided for a rear end of the rotary shaft 33 to pass through. A carbon brush holder 55 is mounted at an internal edge of the rear cover 50. Each of the two screw bolts 60 includes an external thread at a front end thereof and is inserted through one of the two through holes 52 and screwed with one of the threaded holes 42 by the external thread in such a way that the rotor assembly 30, the magnet set 12, and the magnet holder 20 are fully sealed inside the thin body of the irony barrel 11.

As can be know from the above structure, the present invention is characterized in that the magnet holder 20 is mounted inside the thin irony barrel 11 for definitely spacing and positioning the magnets 12a and 12b so as to avoid assembly interference frequently incurred by improper placement or deviation of the magnet set 12 while the front and rear covers of the conventional DC permanent-magnet motor are fixedly connected by the screw bolts. Besides, the magnet holder 20 can structurally reinforce the thin body of the irony barrel 11 to enable the magnet set 12 to have the same thickness W1 as the thickness W of the conventional irony barrel. In other words, the irony barrel 11 of the present invention can save the irony material for its front and rear parts to have preferable material cost.

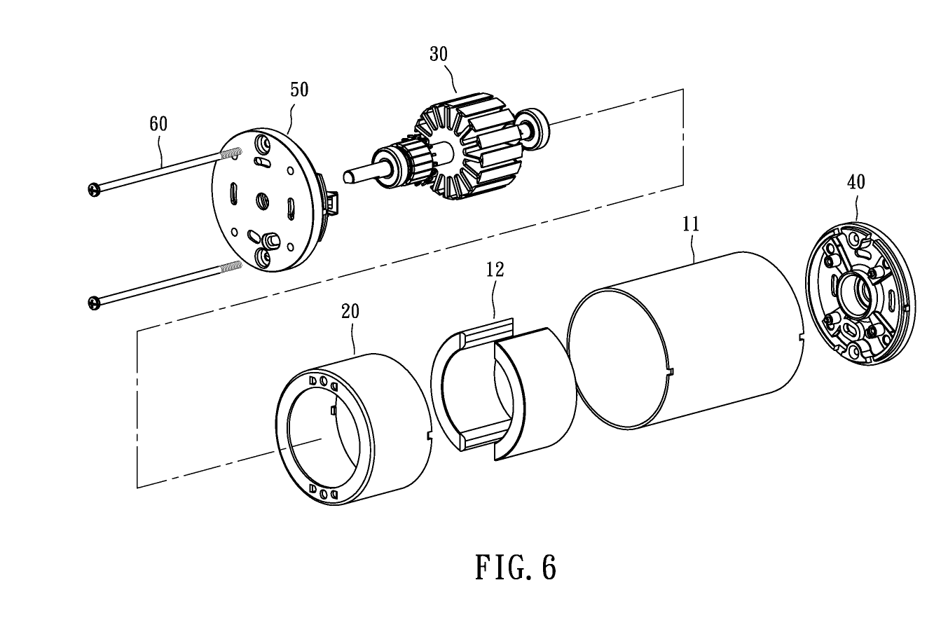

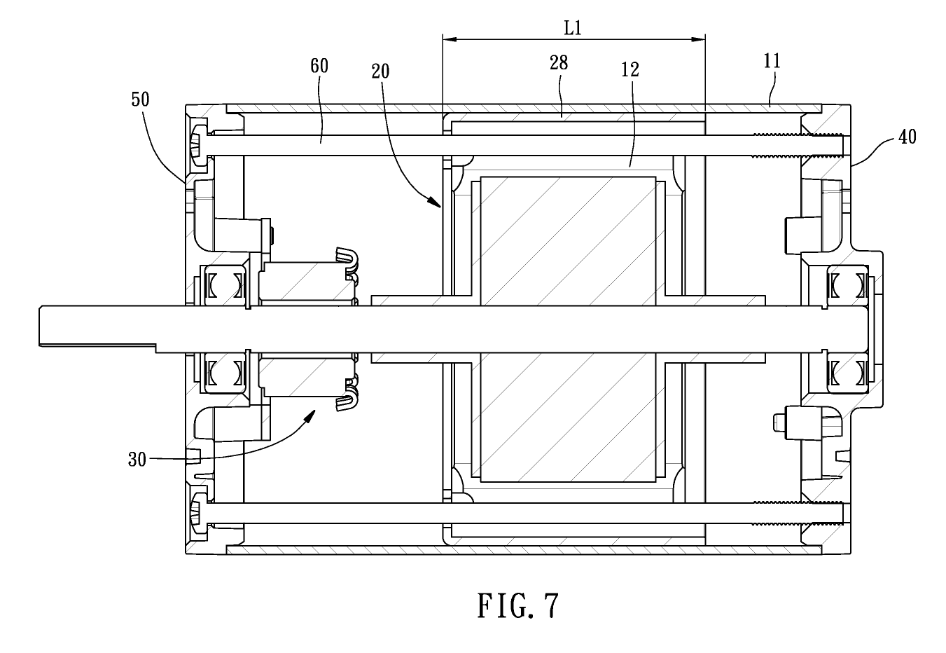

Referring to FIGS. 6-7, a DC permanent-magnet motor constructed according to a second preferred embodiment of the present invention is similar to that of the first embodiment, having the following difference. The magnet holder 20 of the second embodiment includes only one elongated barrel having an annular body 28 whose length L1 is as twice as the length L2 of the rear shell 26 of the first embodiment, such that the magnet set 12 can be fully received in the annular body 28 of the magnet holder 20.

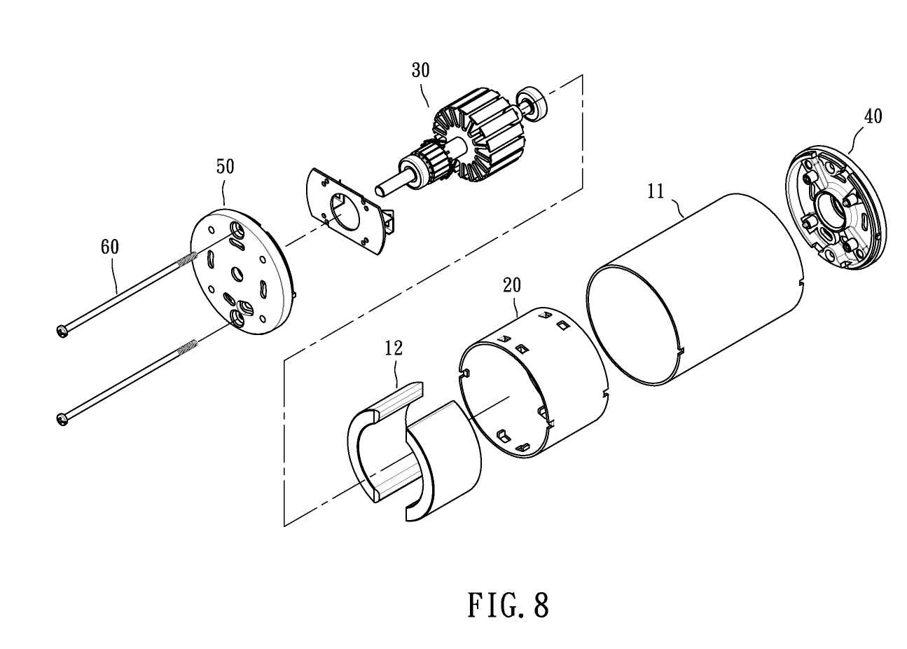

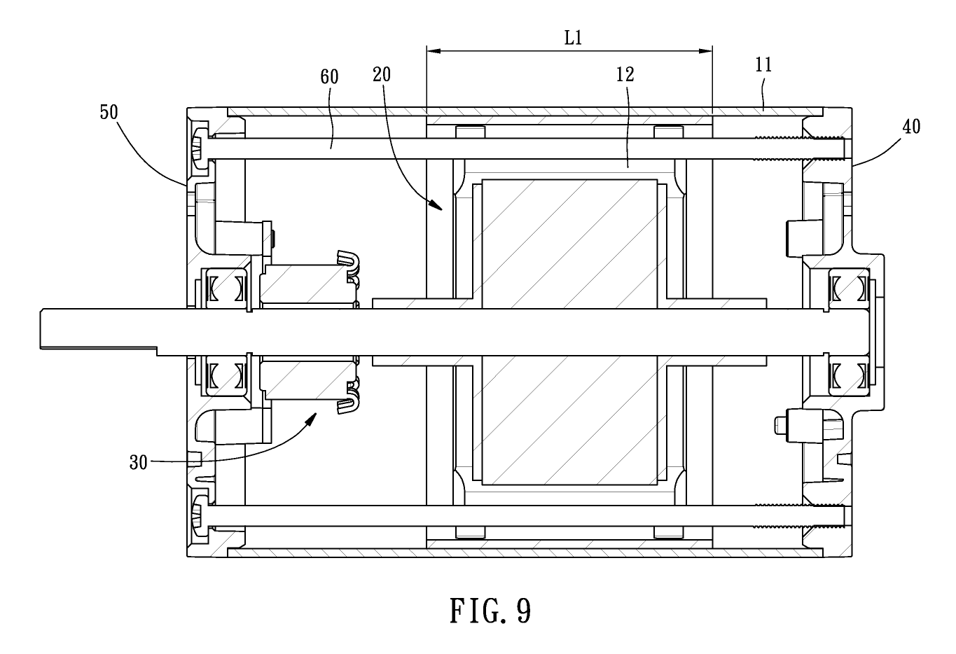

Referring to FIGS. 8-9, a DC permanent-magnet motor constructed according to a third preferred embodiment of the present invention is similar to that of the first embodiment, having the following difference. The magnet holder 20 of the second embodiment includes only one elongated barrel having an annular body whose length L1 is as twice as the length L2 of the rear shell 26 of the first embodiment, such that the magnet set 12 can be fully received in the annular body of the magnet holder 20. Besides, the magnet holder 20 does not includes any annular end sidewall formed at each of two end edges thereof, but the two retaining pieces 26b are still located at the internal side of the annular body of the magnet holder 20. In this way, the magnet set 12 can be inserted and positioned in the magnet holder 20 from a front side or a rear side of the magnet holder 20.

In conclusion, the incorporation of the thin irony barrel 11 and the magnet holder 20 of the present invention can not only maintain the same thickness W1 of the irony material of the magnet set as the thickness W of the conventional irony barrel but also thin the front and rear parts of the irony barrel to effectively lower the irony material cost. In the meantime, the magnet holder 20 definitely spaces and positions the two magnets 12a and 12b for enhanced product assembly efficiency. Therefore, the present invention effectively reduces the production cost of the DC permanent-magnet motor to heighten the product competitiveness.

Although the present invention has been described with respect to specific preferred embodiments thereof, it is in no way limited to the specifics of the illustrated structures but changes and modifications may be made within the scope of the appended claims.

What is claimed is:

1. A permanent-magnet motor comprising:
a barrel assembly having a thin irony barrel, a magnet set, and a magnet holder, the magnet holder being received in the irony barrel and having a plurality of retaining pieces located at an internal edge thereof for holding the magnet set; and
a rotor assembly inserted into the magnet set and having a rotor silicon steel sheet, a rotary shaft, a defector mounted to the rotary shaft, a front bearing mounted to one external end of the rotary shaft, and a rear bearing mounted to the other external end of the rotary shaft.

2. The permanent-magnet motor as defined in claim 1, wherein the magnet holder comprises a front shell and a rear shell, each of the front and rear shells having an annular body, an annular end sidewall extending toward an imaginary central axis from an end edge of the annular body, and a pair of retaining pieces formed at opposite sides of the annular end sidewall.

3. The permanent-magnet motor as defined in claim 2, wherein each of the annular end sidewalls comprises two through holes, each of which is located between one of the two pairs of the retaining pieces.

4. The permanent-magnet motor as defined in claim 1, wherein the magnet holder comprises an elongated barrel, an annular end sidewall extending toward an imaginary central axis from an annular end edge of the elongated barrel, two through holes each formed at one of two opposite sides of the annular end sidewall, and two pairs of retaining pieces, each pair of the retaining piece being located beside one of the through holes.

5. The permanent-magnet motor as defined in claim 1, wherein the magnet holder comprise an elongated barrel, the elongated barrel having pairs of retaining pieces formed at an internal edge thereof, whereby the magnet set can be inserted from a front end or a rear end of the magnet holder and held in the magnet holder.

6. The permanent-magnet motor as defined in claim 1, wherein each of the retaining pieces is a lug.
